(19) United States
(12) Patent Application Publication
(10) Pub. No.: US 2025/0173180 A1
(43) Pub. Date: May 29, 2025

(54) METHOD AND SYSTEM FOR PROVIDING TASK AUTOMATION SERVICE USING LLM

(71) Applicant: SAMSUNG SDS CO., LTD., Seoul (KR)

(72) Inventors: Keun Taek PARK, Seoul (KR); Hyo Young Kim, Seoul (KR); Jae Cheol Lee, Seoul (KR); Seung Woo Lee, Seoul (KR)

(73) Assignee: SAMSUNG SDS CO., LTD., Seoul (KR)

(21) Appl. No.: 18/928,765

(22) Filed: Oct. 28, 2024

(30) Foreign Application Priority Data
Nov. 28, 2023 (KR) 10-2023-0167817
Feb. 8, 2024 (KR) 10-2024-0019964

(51) Int. Cl. G06F 9/48; G06F 21/60

(52) U.S. Cl. CPC G06F 9/4881; G06F 21/602

(57) ABSTRACT

A method for providing task automation service using LLM is provided. The method according to some embodiments may include receiving a description of a target task, generating a first object information list by collecting information on a plurality of objects displayed on a first execution screen of a program used for the target task, selecting at least one candidate object related to the target task from among the plurality of objects by feeding the first object information list and the description of the target task into the LLM, selecting a first target object from among the at least one candidate object by feeding information of the selected candidate object and the description of the target task into the LLM and generating an automation scenario corresponding to the target task based on a first activity related to the first target object.

### CROSS-REFERENCE TO RELATED APPLICATION(S)

This application claims priority from Korean Patent Application No. 10-2023-0167817 filed on Nov. 28, 2023, and Korean Patent Application No. 10-2024-0019964 filed on Feb. 8, 2024, in the Korean Intellectual Property Office, and all the benefits accruing therefrom under 35 U.S.C. 119, the contents of which in their entireties are herein incorporated by reference.

### BACKGROUND

### Technical Field

The present disclosure relates to a method and system for providing a service that automates tasks using a large-scale language model (LLM), and more specifically, to a method for accurately automating complex tasks using an LLM and a system to which the method is applied.

### Description of the Related Art

Robotic process automation (RPA) refers to a technology that allows software robots to mimic and execute simple repetitive tasks performed by users on personal computers (PCs), such as receiving and sending emails, entering data into systems, etc., according to predefined rules.

In the case of conventional RPA solutions, automation is carried out by professional developers who have a certain level of information technology (IT) knowledge and an understanding of tasks to be automated, as they write and refine automation scripts. However, recently, companies introducing RPA solutions prefer solutions that allow business personnel to easily create and automate their own tasks. There is a growing desire for RPA solutions that enable even users unfamiliar with the technology to easily automate tasks, thereby enhancing business efficiency.

Moreover, recently, generative artificial intelligence (AI) technologies such as ChatGPT have been utilized for various purposes across the software industry, and have advanced to the point where they can automatically generate software code under names like “Copilot.” As a result, RPA solution development companies are making significant investments to support RPA process design using generative AI in order to meet market demands.

However, in the current RPA solutions provided by RPA solution development companies, RPA processes are automatically generated through generative AI, but are only created at the level of task flow design. Thus, additional manual modifications are required by users for RPA to be executed. Additionally, in tasks that involve multiple screen transitions, RPA processes cannot be generated with automatic control over the target system or program. Furthermore, there is a limit in transmitting large amounts of information at once to generative AI with a limited number of input tokens. When using external large-scale language models (LLMs), there are also security risks of exposing personal information, such as passwords.

Therefore, there is a need for a technology that can be easily used by users without expertise in RPA solutions while addressing the technical limitations of conventional RPA solutions.

### SUMMARY

Aspects of the present disclosure provide a method and system that allows even

a user who is new to a robotic process automation (RPA) solution to easily automate various high-level tasks.

Aspects of the present disclosure also provide a method and system that can automate tasks involving multiple screen transitions without requiring the user to manually request task automation for each individual screen or directly control a target program.

Aspects of the present disclosure also provide a method and system capable of selecting and processing desired information from the user's input and transmitting it to a large-scale language model (LLM).

Aspects of the present disclosure also provide a method and system that prevents the leakage of the user's personal information to an external LLM during the automation of tasks using an RPA solution.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided for providing task automation service using LLM, performed by a computing system. The method include: receiving a description of a target task, generating a first object information list by collecting information on a plurality of objects displayed on a first execution screen of a program used for the target task, selecting at least one candidate object related to the target task from among the plurality of objects by feeding the first object information list and the description of the target task into the LLM, selecting a first target object from among the at least one candidate object by feeding information of the selected candidate object and the description of the target task into the LLM and generating an automation scenario corresponding to the target task based on a first activity related to the first target object

In some embodiments, the target task may be a task involving screen transitions on a user terminal during task processing.

In some embodiments, the target task may be an automation task performed using information on objects displayed on a screen of a user terminal.

In some embodiments, the first object information list may include at least one of object identifiers (IDs), object names, and object location information.

In some embodiments, the method may further include: before the selecting the at least one candidate object, determining whether the description of the target task contains security information and modifying the description of the target task by transforming the security information based on a result of the determination.

In some embodiments, the generating the automation scenario corresponding to the target task may comprise: controlling the program using information on the first target object; and generating the first activity corresponding to the first target object only if the program is properly controlled.

In some embodiments, the information on the first target object may include encrypted text of security information, and the controlling the program may comprise controlling the program using decrypted data from the encrypted text of the security information.

In some embodiments, the generating the automation scenario may comprise: updating the first execution screen to a second execution screen by performing the first activity related to the first target object; generating a second object information list by collecting information on a plurality of objects displayed on the second execution screen; selecting a second target object using the collected information; and generating the automation scenario corresponding to the target task based on a second activity related to the second target object.

In some embodiments, the selecting the second target object may comprise: selecting at least one candidate object related to the target task from among the plurality of objects by feeding the second object information list and the description of the target task into the LLM; and selecting a second target object from among the at least one candidate object by feeding the information of the selected candidate object and the description of the target task into the LLM.

According to another aspect of the present disclosure, there is provided a method for providing a task automation service using a large-scale language model (LLM), performed by at least one computing device. The method comprising: receiving a description of a target task, determining a candidate activity list related to the target task based on the description of the target task, generating a first prompt for selecting an activity of an automation scenario corresponding to the target task using the description of the target task and information of the candidate activity list, inputting the first prompt into the LLM, and determining at least one activity for processing the target task and generating the automation scenario using the at least one activity.

In some embodiments, the target task may be a task performed on a single screen of a user terminal.

In some embodiments, the target task may be an automation task performed independently of information on objects displayed on a screen of a user terminal.

In some embodiments, the determining the candidate activity list may comprise: generating a second prompt for selecting the candidate activity list related to the target task using the description of the target task and information of activity lists registered in a task automation system and determining the candidate activity list related to the target task by inputting the second prompt into the LLM.

In some embodiments, the determining the at least one activity may comprise: identifying missing attribute information in the description of the target task among attribute information of the at least one activity for performing the at least one activity; generating one or more variables corresponding to the missing attribute information; and updating the attribute information of the at least one activity by adding the one or more variables to the attribute information of the at least one activity.

In some embodiments, the method may further comprise: if the candidate activity list does not exist, determining a sub-activity for processing the target task using the LLM, and generating the automation scenario corresponding to the target task using the sub-activity.

According to another aspect of the present disclosure, there is provided a system for providing a task automation service using a large-scale language model (LLM). The system comprising: a processor and a memory storing instructions, wherein when executed by the processor, the instructions cause the processor to: receive a description of a target task; generate a first object information list by collecting information on a plurality of objects displayed on a first execution screen of a program used for the target task, select at least one candidate object related to the target task from among the plurality of objects by feeding the first object information list and the description of the target task into the LLM, select a first target object from among the at least one candidate object by feeding information of the selected candidate object and the description of the target task into the LLM, and generate an automation scenario corresponding to the target task based on a first activity related to the first target object.

In some embodiments, the target task may be a task involving screen transitions on a user terminal during task processing.

In some embodiments, when executed by the processor, the instructions may further cause the processor to: before selecting the at least one candidate object from among the plurality of objects, determine whether the description of the target task contains security information and modify the description of the target task by transforming the security information based on a result of the determination.

According to another aspect of the present disclosure, there is provided a system for providing a task automation service using a large-scale language model (LLM), the system comprising, a processor and a memory storing instructions, wherein when executed by the processor, the instructions cause the processor to: receive a description of a target task; determine a candidate activity list related to the target task based on the description of the target task; generate a first prompt for selecting an activity of an automation scenario corresponding to the target task using the description of the target task and information of the candidate activity list and determine at least one activity for processing the target task by inputting the first prompt into the LLM; and generate the automation scenario using the at least one activity.

In some embodiments, the target task may be a task performed on a single screen of a user terminal.

According to the aforementioned and other embodiments of the present disclosure, by appropriately using a static generation module and a dynamic generation module based on the type of task, an optimal automation scenario corresponding to a user's task can be provided, thereby effectively enhancing user satisfaction and task convenience.

According to the aforementioned and other embodiments of the present disclosure, for a task involving multiple screen transitions, the user does not need to request the generation of an automation scenario for each individual screen, as the RPA solution automatically controls each screen and generates an automation scenario for the task input by the user, thereby effectively improving user satisfaction and task convenience.

According to the aforementioned and other embodiments of the present disclosure, by considering the maximum number of tokens that can be input into an LLM, unnecessary data or less relevant data is deleted during the transmission of various types of information to the LLM. This prevents errors that may occur during an automation scenario generation process and ensures that the optimal response to the user's request is provided.

According to the aforementioned and other embodiments of the present disclosure, for a task performed on a single screen, the user does not need to manually input an automation target and control operation within the flow of the task. The RPA solution automatically generates activities within the task flow using an LLM, thereby effectively enhancing user satisfaction and task convenience.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary flowchart of a method for providing a task automation service using a large-scale language model (LLM), according to some embodiments of the present disclosure;

FIG. 2 is a flowchart for explaining a method for providing a task automation service using an LLM, performed by a dynamic generation module, according to an embodiment of the present disclosure;

FIG. 3 is an exemplary diagram of an object information list, which may be referenced in some embodiments of the present disclosure;

FIG. 4 is a detailed flowchart for explaining additional operations that can be added to the method of FIG. 2;

FIG. 5 is an exemplary diagram for explaining some of the operations illustrated in FIG. 2;

FIG. 6 is an exemplary diagram for explaining some of the operations illustrated in FIG. 2;

FIG. 7 is a detailed flowchart for explaining additional operations that can be added to the method of FIG. 2;

FIG. 8 is a flowchart illustrating a method for providing a task automation service using an LLM, performed by a static generation module, according to an embodiment of the present disclosure;

FIGS. 9 and 10 are detailed flowcharts for explaining some of the operations illustrated in FIG. 8;

FIG. 11 is a detailed flowchart for explaining some of the operations illustrated in FIG. 8; and

FIG. 12 is a hardware configuration diagram of a system for providing a task automation service using an LLM, according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms.

Embodiments of the present disclosure will be described with reference to the attached drawings.

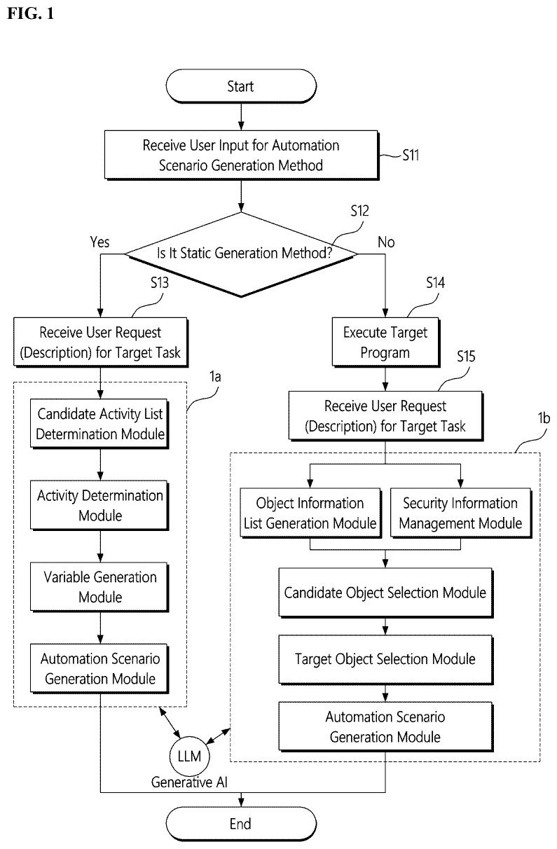

FIG. 1 is a flowchart of a method for providing a task automation service using a large-scale language model (LLM), according to some embodiments of the present disclosure.

As illustrated in FIG. 1, the method for providing a task automation service using an LLM, according to some embodiments of the present disclosure, may begin with step S11, where a selection input for an automation scenario generation method is received from a user. Here, the automation scenario generation method may include a static generation method performed by a static generation module la and a dynamic generation method performed by a dynamic generation module 1b.

Specifically, the static generation module la, which is a module that automates a task that is not dependent on the execution screen of a program (i.e., a target program for task automation) for use in tasks, may include a candidate activity list determination module, an activity determination module, a variable generation module, and an automation scenario generation module. Additionally, the dynamic generation module 1b, which is a module that creates an automation scenario for a task that is dependent on the execution screen of the program, while controlling the execution screen, includes an object information list generation module, a security information management module, a candidate object selection module, a target object selection module, and an automation scenario generation module.

First, if it is determined in step S12 that the user has selected the static generation method, the user's description (i.e., user request, query, etc.) regarding a target task to be automated may be received in step S13.

When the user selects the static generation method, the candidate activity list determination module of the static generation module la generates a prompt for selecting a candidate activity list by using the user's description and information for activity lists registered in a task automation system, and inputs the generated prompt into an LLM to determine a candidate activity list for the target task. The activity determination module generates a prompt for selecting an activity that is most suitable to the user's intent by using the user's description and the candidate activity list determined by the candidate activity list determination module, and inputs the generated prompt into the LLM to determine at least one activity for processing the target task. The variable generation module may substitute information not directly input by the user, among the attributes of the activity determined by the activity determination module, with variables. These variables may be either existing variables already registered in the task automation system or new variables generated by an artificial intelligence (AI) model. Afterward, the automation scenario generation module may create an automation scenario corresponding to the target task by using the activity determined by the activity determination module and the variables generated/substituted by the variable generation module.

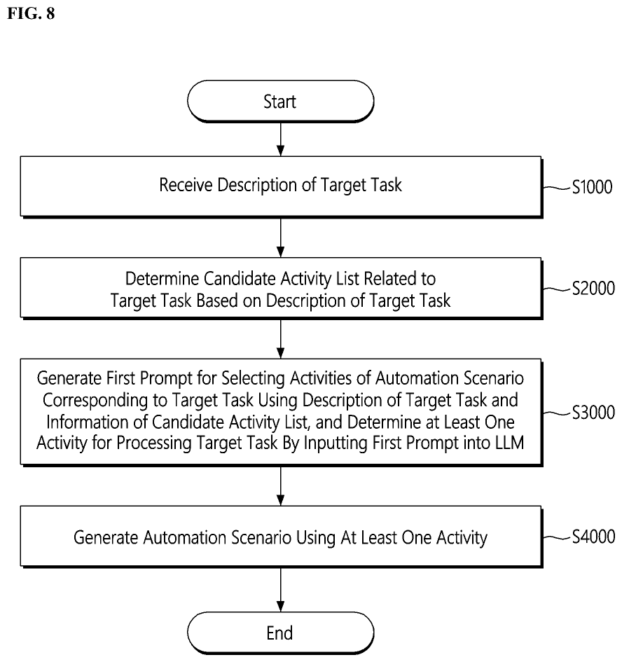

A further detailed description of each process performed by the static generation module la will be described later with reference to FIGS. 8 through 11.

Thereafter, if it is determined in step S12 that the user has selected the dynamic generation method, a target program, system, or application (e.g., the Windows system, Chrome browser, Edge browser) for the target task may be executed in step S14, and the user's description (i.e., user request, query, etc.) regarding the target task may be received.

The object information list generation module of the dynamic generation module 1b may collect information on objects displayed on the execution screen of the target program and process the collected information according to a predefined format. The security information management module may store and manage security information set by the user. In addition, the security information management module may determine whether the user's description includes security information set in advance, and if security information is included, the security information management module may transmit the user's description with the security information modified to the LLM.

Thereafter, the candidate object selection module may generate a prompt for selecting candidate objects related to the target task by using the object information list generated by the object information list generation module and the description of the target task modified by the security information management module, and may select the candidate objects related to the target task by inputting the generated prompt into the LLM. The target object selection module may generate a prompt for determining an object that are most suitable for the user's intent by using the candidate objects selected by the candidate object selection module and the description of the target task, and may determine a target object for processing the task by inputting input the generated prompt into the LLM. At this point, control information for controlling the target object may be obtained. Thereafter, the automation scenario generation module may control the target program by using information on the target object determined by the target object selection module, and may generate an automation scenario corresponding to the target task based on the result of the control.

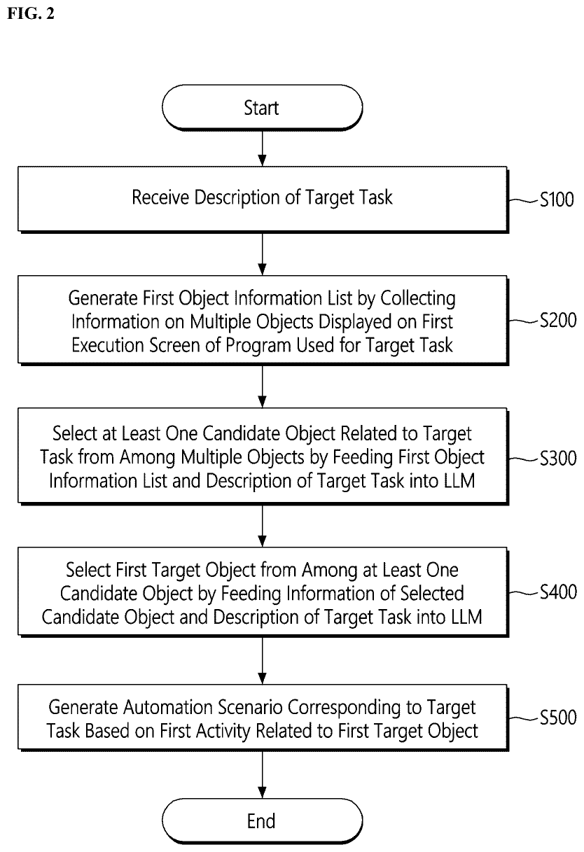

A further detailed explanation of each process performed by the dynamic generation module 1b will be described later with reference to FIGS. 2 through 7.

In summary, based on the user's selection input for how to generate an automation scenario, automation scenarios for various tasks requested by the user can be generated through either the dynamic generation module 1b or the static generation module la. In this case, the dynamic generation module 1b and the static generation module la may both determine the most suitable object or activity for the user's desired task by interacting with the LLM, and may generate an automation scenario for the corresponding target using the determined object or activity.

Therefore, by appropriately using the static generation module la and dynamic generation module 1b according to the type of task, the optimal automation scenario for the user's task can be provided, effectively enhancing user satisfaction and task convenience.

A further detailed description of the method for providing a task automation service using an LLM according to some embodiments of the present disclosure will hereinafter be provided with reference to FIG. 2 and its subsequent drawings. First, a detailed explanation of specific processes performed by the static generation module la will be provided with reference to FIGS. 2 through 7.

FIG. 2 is a flowchart illustrating a method for providing a task automation service using an LLM, performed by the dynamic generation module 1b, according to one embodiment of the present disclosure. However, the embodiment of FIG. 2 is merely exemplary, and certain steps may be added or deleted, as necessary.

For reference, FIG. 2 illustrates steps/operations of the method performed by the dynamic generation module 1b of FIG. 1. Therefore, even if the subject of each particular step/operation is omitted in the following description, it may be understood that the corresponding step/operation is performed by the dynamic generation module 1b.

As illustrated in FIG. 2, the method for providing a task automation service using LLM according to one embodiment of the present disclosure may begin with step S100, where a description of the target task is received from the user. Here, the description of the target task may refer to a text-based command or request regarding the target task. Additionally, the target task may be a task that involves screen transitions on the user terminal when being processed by the user using a relevant program, or may be an automation task performed using information on objects displayed on the screen of the user terminal.

In step S200, the object information list generation module of the dynamic generation module 1b may collect information on multiple objects displayed on a first execution screen of the target program used for the target task and generate a first object information list. Here, the first object information list may be generated based on the attributes of the objects and the format of each object information list, which are predefined by the user. Additionally, the first object information list may include at least one of the identifiers (IDs), names, or location information of the multiple objects.

That is, when the user intends to automate a task involving multiple screen transitions in a web browser, the information on the objects displayed on the first execution screen (e.g., a search input area, advertisement image, ID/PW input area, search button area, etc.) may all be collected, and an object information list for the objects displayed on the first execution screen may be generated based on predefined object attributes and the list format.

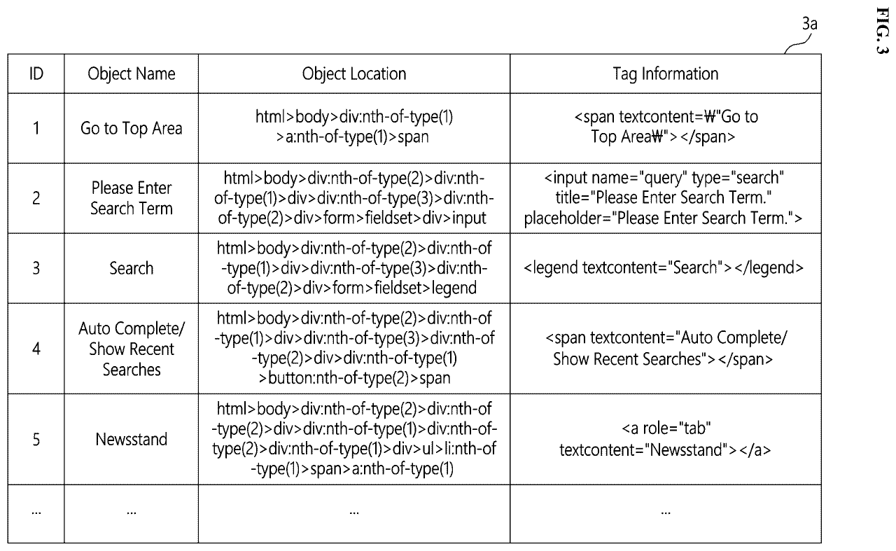

For example, referring to FIG. 3, as a result of collecting and processing information on multiple objects displayed on the execution screen of the target program (e.g., the Chrome browser), an object information list 3a may be generated. As illustrated in FIG. 3, the object information list 3a may include the ID numbers, names, locations, and tag information of each object displayed on a particular screen.

However, the object attribute information shown in FIG. 3 is merely exemplary, and the present disclosure is not limited thereto. That is, the attributes or classification items of objects may be set in various manners by the user.

Referring again to FIG. 2, in step S300, the candidate object selection module may select one or more candidate objects related to the target task from among the multiple objects by feeding the first object information list generated in step S200 and the description of the target task into the LLM. In this case, the prompt generated to select the candidate objects related to the target task using the LLM may include the first object information list, or may include processed data from the first object information list. That is, considering a limited number of tokens that can be input into the LLM, if the combined number of tokens from the first object information list and tokens from the description of the target task exceeds a threshold, a list with some object attribute information removed from the multiple objects in the first object information list may be generated, and a prompt containing this generated list may be used to select the candidate objects related to the target task.

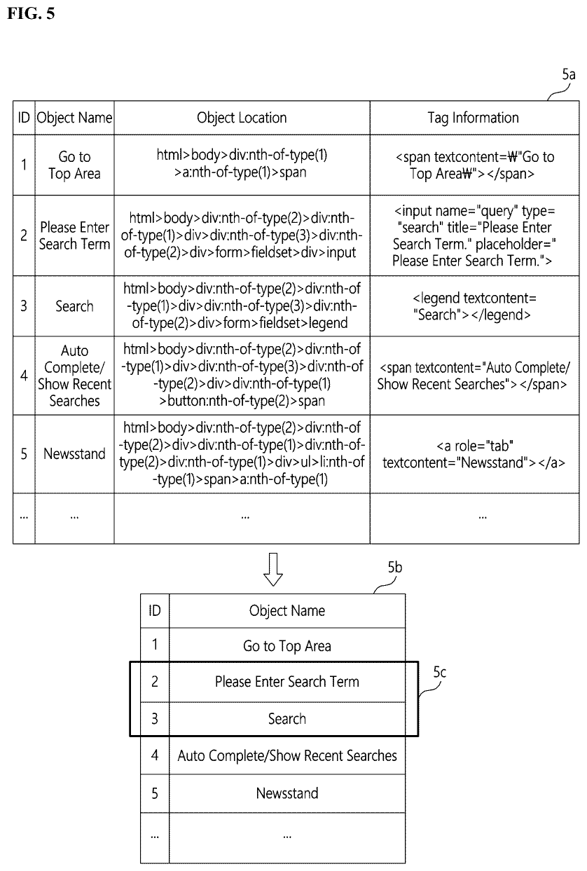

For example, from a first object information list including information such as the IDs, names, locations, sizes, and colors of objects, a list with both the objects' IDs and names both removed may be generated, and a prompt based on this generated list and the description of the target description may then be fed into the LLM, resulting in the selection of one or more candidate objects related to the target task. This will be described later in detail with reference to FIG. 5.

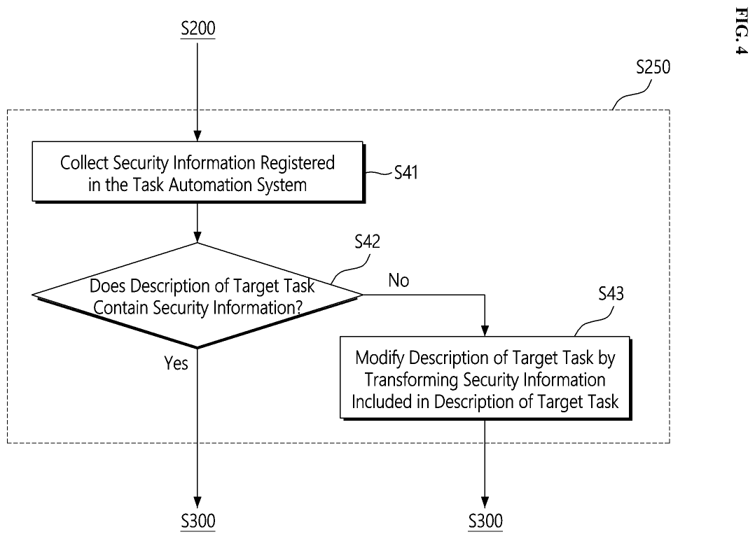

Meanwhile, although not specifically illustrated in FIG. 2, a determination may be made as to whether the description of the target task input by the user contains the security information set in advance to prevent personal information or internal corporate information from being input into the LLM. In other words, if the description of the target task includes security information such as passwords, the passwords may be encrypted or modified before being input into the LLM, and then, processes may be selectively performed. This will be described later in detail with reference to FIG. 4.

In step S400, the target object selection module may feed the information of the candidate objects selected by the candidate object selection module and the description of the target task into the LLM to select a target object corresponding to the target task from among the candidate objects. In this case, the first target object refers to the object most closely related to the target task, which may differ from other candidate objects that are merely related to the target task. That is, the LLM may determine the object most relevant to the target task from among the candidate objects as the first target object. Additionally, the LLM may output the first target object and its control information.

Additionally, the prompt input into the LLM may include processed data from the first object information list generated in step S200 using information on the candidate objects. In other words, the information on the candidate objects selected by the candidate object selection module may include only partial object attribute information (e.g., object IDs, object names, etc.) for the candidate objects. Accordingly, to enable the LLM to select the most appropriate object for the user's intended task, the first object information list may be processed to generate a list containing only the attribute information of the selected candidate objects, and a first target object that is most suitable for the target task may be selected using a prompt containing this generated list.

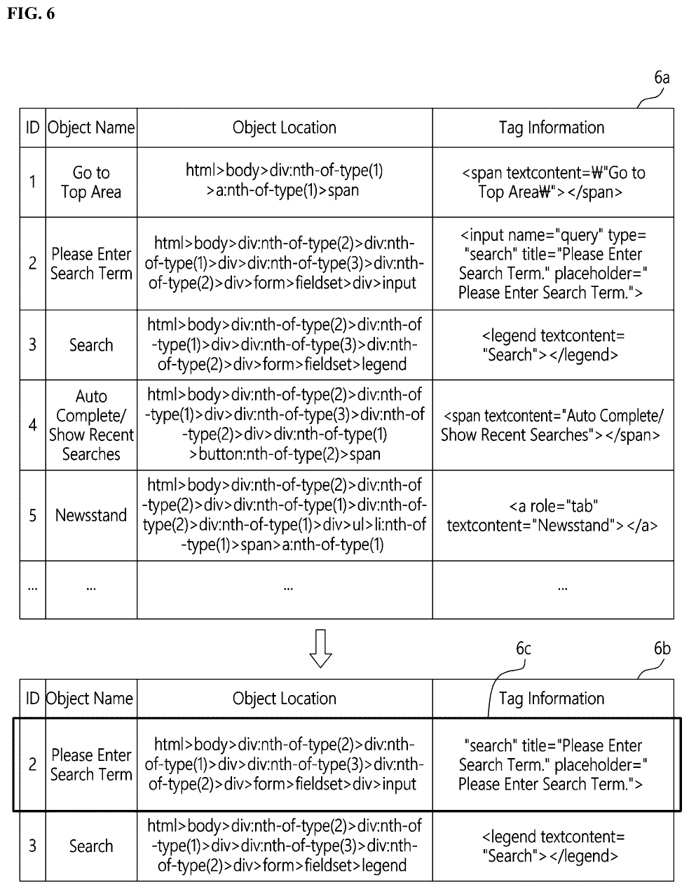

For example, a list containing only the information of the candidate objects selected by the candidate object selection module may be generated from the first object information list that includes information such as object IDs, object names, object locations, object sizes, and object colors, and by inputting the prompt generated from this list and the description of the target task into the LLM, the first target object corresponding to the target task may be selected. This will be described later in detail with reference to FIG. 6.

In step S500, the automation scenario generation module may generate an automation scenario corresponding to the target task based on a first activity related to the first target object selected by the target object selection module. Specifically, the automation scenario generation module may determine whether information on the first target object (e.g., target object control information) obtained in step S400 contains any errors, and if errors are detected, the automation scenario generation module may display an error message. Additionally, if no errors are found in the information on the first target object, the automation scenario generation module may control the target program using the control information for the first target object. Then, if the target program is properly controlled, the automation scenario generation module may generate the first activity corresponding to the first target object. At this time, if the information on the first target object contains security-related information (i.e., encrypted or modified security information), the security-related information may be decrypted, and the target program may be controlled using the decrypted information.

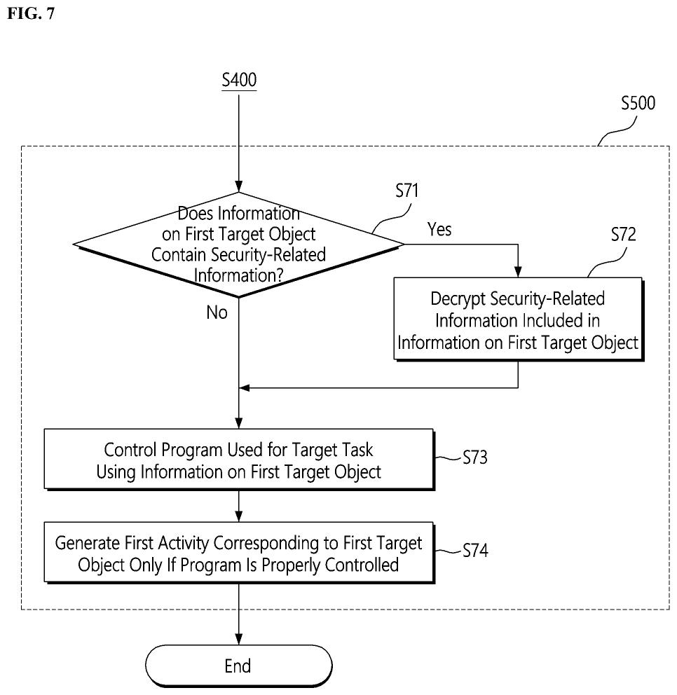

Although not specifically illustrated in FIG. 2, when the generation of the first activity related to the first execution screen is completed, the dynamic generation module 1b may collect information on multiple objects displayed on a second execution screen of the target program, into which the first execution screen transitions after the first activity is performed, and may thereby generate a second object information list. Thereafter, the dynamic generation module 1b may select one or more candidate objects related to the target task from the second object information list, may select a second target object corresponding to the target task on the second execution screen from among the selected candidate objects, and may generate a second activity corresponding to the target task on the second execution screen, using the second target object. That is, the steps described above with reference to FIG. 2, i.e., steps S200, S300, S400, and S500, may be repeatedly performed for different execution screens of the target program. This will be described later in detail with reference to FIG. 7.

In summary, in response to a user request for a target task that involves multiple screen transitions being received, a first object information list generated by collecting information on objects displayed on a first execution screen and the user request may be fed into the LLM, and one or more candidate objects related to the target task may be selected, a first target object that is most appropriate for processing the target task may be selected from the candidate objects using the LLM, and an automation scenario corresponding to the target task may be generated based on the activity related to the selected first target object. In this case, the prompt sent to the LLM may include processed data from the first object information list. Additionally, when the selection of the first target object and the generation of an automation scenario for the first execution screen are completed, the processes of collecting object information, selecting candidate objects, and selecting a target object for a second execution screen may be repeatedly performed after transitioning from the first execution screen to the second execution screen.

Therefore, for the target task that involves multiple screen transitions, the user does not need to request the generation of an automation scenario for each individual screen, and a robotic process automation (RPA) solution can automatically generate an automation scenario for the target task input by the user, while automatically control each screen, thus significantly improving user satisfaction and task convenience. Additionally, by sending information to the LLM through appropriate procedures (e.g., removing unnecessary data) in consideration of the maximum number of tokens that can be input into the LLM, errors that may occur during the generation of the automation scenario can be prevented, and the optimal response to the user request can be provided.

A task automation process performed by the dynamic generation module 1b will hereinafter be described with reference to FIGS. 4 through 7.

FIG. 4 is a detailed flowchart for explaining additional operations that can be added to the method illustrated in FIG. 2. Specifically, FIG. 4 is a detailed flowchart illustrating the processes of determining whether pre-set security information is included in the description of the target task input by the user and modifying the description of the target task based on the result of the determination.

As illustrated in FIG. 4, before step S300, where one or more candidate objects related to the target task are selected from among the multiple objects using the LLM, step S250 may be performed where a determination is made as to whether security information is included in the description of the target task and the description of the target task is modified by modifying the security information based on the results of this determination. Here, the security information may refer to high-security information set in advance by the user (e.g., the user account's password, bank account number, contact information, etc.). According to this embodiment, security issues can be addressed by preventing the transmission of personal information (e.g., the user account's ID/PW) or corporate internal information to the LLM.

In step S41, the security information management module may collect security information registered in the task automation system. Additionally, in step S42, the security information management module may compare the collected security information with the description of the target task input by the user to determine whether the description of the target task contains any security information.

First, if the description of the target task input by the user does not contain any security information (e.g., the user account's password), the process of modifying the description of the target task is not performed, and step S300, where candidate objects related to the target task are selected by feeding the object information list generated by the object information list generation module and the description of the target task into the LLM, may be performed.

Conversely, if the description of the target task input by the user contains security information (e.g., the user account's password), in step S43, the security information management module may modify the description of the target task by transforming the security information included in the task description. For example, if “password123” is included in the description of the target task input by the user as pre-set security information, the security information management module may modify the description of the target task by transforming “password123” into “@@password123@@,” but the present disclosure is not limited thereto. That is, various encryption or transformation methods may be applicable to prevent security information from being transmitted to the LLM.

Thereafter, step S300 may be performed, where candidate objects related to the target task are selected by feeding the modified description of the target task from step S43 and the object information list generated by the object information list generation module into the LLM.

In summary, if the description of the task input by the user contains security information, the task description may be modified by encrypting or transforming the security information before transmitting the task description to the LLM.

Thus, security issues can be resolved by preventing the exposure of security information, such as personal information or corporate internal information, to an external LLM.

FIG. 5 is an exemplary diagram for explaining some of the operations illustrated in FIG. 2. Specifically, FIG. 5 is an exemplary diagram for explaining step S300 of FIG. 2, where one or more candidate objects related to the target task are selected from among a plurality of displayed objects.

In step S300, before inputting the first object information list generated from the information collected from the first execution screen of the target program into the LLM, the candidate object selection module may process the first object information list into an appropriate form in consideration of the number of tokens that can be input into the LLM. That is, when generating a prompt for selecting candidate objects related to the target task, there may arise a case where the first object information list containing the information of all the objects displayed on the first execution screen may exceed the maximum number of tokens allowed, and thus, the candidate object selection module may process the first object information list to generate a list with some object attribute information removed.

As illustrated in FIG. 5, a first object information list 5a may include information on multiple objects displayed on the first execution screen of the target program (e.g., object IDs, object names, object locations, object tag information, etc.). The candidate object selection module may remove some of the attribute items from the first object information list 5a and generate a first object information list 5b that contains only the object IDs and object names. Thereafter, the candidate object selection module may generate a prompt based on the first object information list 5b and the description of the target task, and transmit the generated prompt to the LLM, and the LLM may output the result of the selection of one or more candidate objects related to the target task. For example, if the target task is related to a “search” (e.g., a knowledge search for task-related information, a keyword search within a document, etc.), the LLM may select candidate objects with IDs 2 and 3, which are related to a “search” task, as illustrated in a box 5c.

In other words, the candidate object selection module of the dynamic generation module 1b may generate a list with some object attribute information removed from the multiple objects included in the object information list, and may select one or more candidate objects related to the target task using a prompt containing this list.

FIG. 6 is an exemplary diagram for explaining some of the operations illustrated in FIG. 2. Specifically, FIG. 6 is an exemplary diagram for explaining step S400 of FIG. 2, where a first target object is selected from among one or more objects.

In step S400, where a target object is selected, the first object information list, generated based on the information collected from the first execution screen of the target program, may be processed into an appropriate format before being input into the LLM to allow the user to select the most suitable target object for the target task. That is, when generating a prompt for selecting a target object corresponding to the target task, if the first object information list containing the information of all the objects displayed on the first execution screen is input into the LLM, the accuracy of the selected target object may be low. Therefore, the target object selection module may process the first object information list to generate a list containing only the attribute information of the candidate objects.

As illustrated in FIG. 6, the first object information list 5a may include information on the multiple objects displayed on the first execution screen of the target program (e.g., object IDs, object names, object locations, object tag information, etc.). The target object selection module may remove the information on all the objects except for the candidate objects with IDs 2 and 3 selected from the first object information list 5a, and generate a second object information list 6b containing only the attribute information of the selected candidate objects. Thereafter, the target object selection module may generate a prompt based on the second object information list 6b and the description of the target task, and send the generated prompt to the LLM. Then, the LLM may output the result of the selection of the first target object corresponding to the target task.

For example, if the target task is related to a “search,” such as a task-related knowledge search or a keyword search within a sentence, and specifically involves a “search query input” task, the LLM may select the candidate object with ID 2 as a target object related to the “search query input” task, as illustrated in a box 6c.

That is, to allow the LLM to select the most suitable object for the user's intended task, the first object information list may be processed to generate a list that contains only the attribute information of the selected candidate objects, and may select the most relevant target object to the target task using a prompt containing this list.

FIG. 7 is a detailed flowchart for explaining additional operations that can be added to the method illustrated in FIG. 2. Specifically, FIG. 7 is a detailed flowchart illustrating the processes where the automation scenario generation module controls the target program using information on the first target object selected by the target object selection module and generates an activity corresponding to the selected target object based on the result of the control. However, the embodiment of FIG. 7 is merely exemplary, and certain steps may be added or deleted, as necessary.

The information on the first target object selected by the target object selection module may include control information for the first target object. That is, the target object selection module may generate information on the first target object corresponding to the target task and control information (i.e., a control method) for the first target object using the LLM. If there is an error in the control information of the first target object (e.g., if there is no control information at all or if there is no matching control information), a message indicating that an error has occurred during an automation process generation may be sent to the user terminal. A process to be performed when there is no error in the control information of the first target object will hereinafter be described.

In step S71, a determination may be made as to whether the information on the first target object includes security-related information. The security-related information may refer to encrypted or transformed security information, as explained earlier with reference to FIG. 4. That is, a determination may be made as to whether the information on the first target object includes encrypted text (e.g., “@@password123@@”) for the security information (e.g., “password123”) of the first target object.

First, in step S72, if the information on the first target object is determined as containing security-related information, the security-related information included in the information on the first target object may be decrypted. That is, the encrypted or modified text (e.g., “@@password123@@”) may be decrypted back into the security information (e.g., “password123”). This is because the target program cannot be accurately controlled using encrypted or modified security information. For example, if the target task includes logging into the user account using the user's ID/PW, the target program cannot automatically perform the login task desired by the user with encrypted or modified ID/PW.

In step S73, the target program may be controlled using the information on the first target object (including the control information). This step may be interpreted as a procedure for performing a virtual simulation to verify whether the task automation process operates properly using the information on a final selected target object. Thereafter, in step S74, only if the target program is controlled properly in step S73, the first activity corresponding to the first target object may be generated.

In summary, the automation scenario generation module may perform a control simulation on the target program using the information on the target object, and may generate an automation scenario by determining the first activity corresponding to the first target object only if the target program is controlled properly. In this process, if the information on the first target object output by the LLM includes encrypted security information, a decryption process for decrypting the encrypted security information may be performed to ensure that the target program is controlled properly.

As a result, by performing verification/evaluation of whether the target program is controlled properly with the first target object, the accuracy of the generated automation scenario and user satisfaction with the target task requested by the user can be improved.

The method for providing a task automation service using an LLM through a dynamic generation module according to some embodiments of the present disclosure has been described so far with reference to FIGS. 1 through 7. However, there may be tasks to be automated by the user that do not involve screen transitions of a task-related program, system, or application. A method for providing a task automation service using an LLM through a static generation module according to some embodiments of the present disclosure will hereinafter be described with reference to FIGS. 8 through 11.

FIG. 8 is a flowchart illustrating the method for providing a task automation service using an LLM, performed by the static generation module la, according to one embodiment of the present disclosure. However, the embodiment of FIG. 8 is merely exemplary, and certain steps may be added or deleted, as necessary.

For reference, FIG. 8 illustrates the steps/operations of the method performed by the static generation module la of FIG. 1. Therefore, even if the subject of each particular step/operation is omitted in the following description, it may be understood that the corresponding step/operation is performed by the static generation module la.

As illustrated in FIG. 8, the method for providing a task automation service using an LLM according to one embodiment of the present disclosure may begin with step S1000, where a description of a target task is received from a user. Here, the description of the target task may refer to a text-based command or request regarding a task to be automated by the user or the target task. Here, the target task may be a task that does not involve screen transitions on the user terminal during processing using a task-related program (i.e., a task performed on a single screen of the user terminal) or an automation task performed independently of information displayed on the screen of the user terminal.

In step S2000, the candidate activity list determination module of the static generation module la may determine a candidate activity list related to the target task based on the description of the target task. At this time, the candidate activity list determination module may generate a prompt for selecting an activity list related to the target task from among the activity lists registered in the task automation system, and may determine the candidate activity list using the generated prompt.

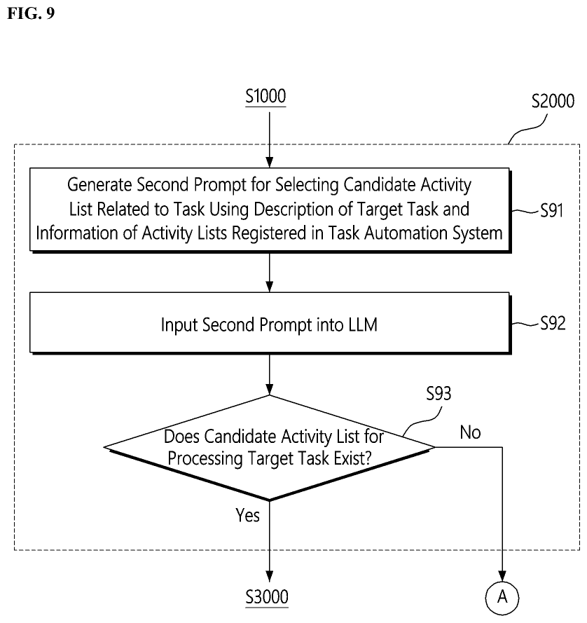

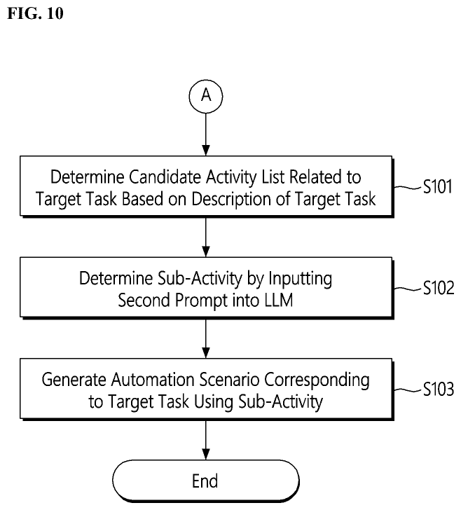

Meanwhile, there may be cases where the candidate activity list for processing the target task input by the user does not exist in the task automation system. In such cases, the activity determination module may later extract a sub-activity for generating a custom scenario using the LLM. This will be described later in detail with reference to FIGS. 9 and 10.

In step S3000, the activity determination module may generate a first prompt for selecting an activity for an automation scenario corresponding to the target task by using information from the candidate activity list determined in step S2000 and the description of the target task, and may determine at least one activity for processing the target task by inputting the first prompt into the LLM. That is, among multiple activities included in the candidate activity list related to the target task, at least one suitable activity for processing the target task may be extracted. At this time, attribute information of the at least one activity may also be extracted.

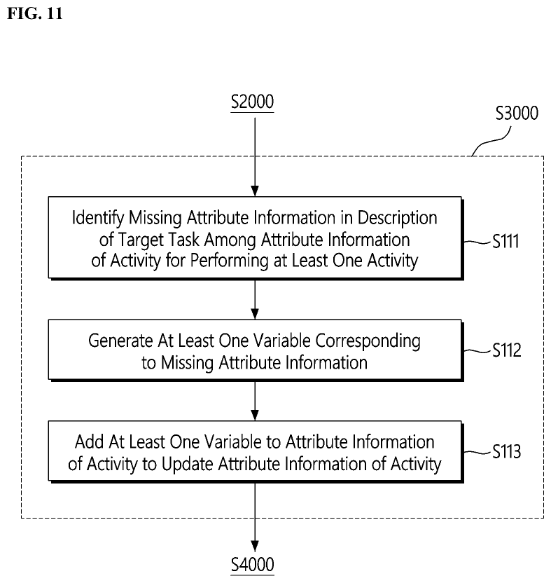

Meanwhile, although not illustrated in FIG. 8, step S3000, where at least one activity for processing the target task is determined, may include steps/operations of identifying activity attribute information not input by the user and substituting it with appropriately named variables to ensure that the activity for processing the target task is extracted accurately. This will be described later in detail with reference to FIG. 11.

In step S4000, the automation scenario generation module may generate an automation scenario corresponding to the target task using information and variable information of the activity determined in step S3000. Specifically, the automation scenario generation module may generate an automation activity template for each activity using information and variable information of each activity and may set the attribute values of each activity to create an automation process for each activity. By repeating these steps/operations, a final automation scenario for multiple activities may be generated.

In summary, when a user request for a task performed on a single screen is received, a candidate activity list related to the task may be determined based on the user request, and at least one activity suitable for processing the task may be selected from the candidate activity list by inputting a prompt generated based on the candidate activity list and the user request into the LLM. Then, an automation scenario corresponding to the task may be generated using the determined activity. At this time, the prompt sent to the LLM may include processed data (e.g., summarized data) in consideration of the number of tokens that can be input into the LLM. Additionally, a final automation scenario may be generated by sequentially processing the activity selected for the task.

For example, if the user inputs a description of a first task, such as “Create a new Excel sheet and fill a specific cell with yellow,” the candidate activity list determination module may select a candidate activity list (e.g., an activity list for creating an Excel sheet, an activity list for coloring a specific cell in Excel, etc.) from among the activity lists registered in the task automation system, using the LLM. Thereafter, the activity determination module may select at least one activity (e.g., “Create Excel file,” “Set cell color,” etc.) suitable for processing the first task from the candidate activity list, using the LLM. At this time, the variable generation module may generate variables (e.g., “file_path,” “cell_location,” etc.) for an activity attribute value not input by the user, such as the file path of a created file or location information of a specific cell. The automation scenario generation module may generate an automation scenario corresponding to the first task using the information and variable information of the selected activity, as well as the activity attribute values additionally input by the user.

Therefore, for a task performed on a single screen, an RPA solution can automatically generate activities within a task flow using the LLM without having the user manually input an automation target and a control action for each part of the task flow, thereby significantly improving user satisfaction and task convenience. Additionally, by sending various information to the LLM through appropriate procedures (e.g., deleting data that is less relevant to the task) in consideration of the number of tokens that can be input into the LLM, errors that may occur during an automation scenario generation process can be prevented, and the optimal response to the user request can be provided.

FIGS. 9 and 10 are detailed flowcharts for explaining some of the operations illustrated in FIG. 8. Specifically, FIGS. 9 and 10 are flowcharts for explaining processes to be performed when there exists or does not exist a candidate activity list related to the target task output through the LLM based on the description of the target task. However, the embodiment of FIGS. 9 and 10 is merely exemplary, and certain steps may be added or deleted, as necessary.

As illustrated in FIG. 9, step S2000, where a candidate activity list related to the target task is determined based on the description of the target task, may include step S91, where a second prompt is generated to select an activity list related to the target task using the description of the target task and the information of the activity lists registered in the task automation system; step S92, where the second prompt is input into the LLM; and step S93, where a determination is made as to whether the output of the LLM contains a candidate activity list related to the target task.

First, if a candidate activity list related to the target task exists, step S3000 may be performed, where at least one activity for processing the target task is determined using information of the candidate activity list output from the LLM and the description of the target task.

Thereafter, there may be cases where the candidate activity list related to the target task does not exist, such as when the user requests automation of a target task not supported by the task automation system. In other words, there may be cases where the activity list or activity corresponding to the description of the target task input by the user is not registered in the task automation system. In such cases, a process for generating a custom scenario with minimal user intervention in the task automation process may be performed.

As illustrated in FIG. 10, in step S101, if the candidate activity list related to the target task is determined in step S93 of FIG. 9 to not exist, the activity determination module may generate a second prompt for determining a sub-activity related to the target task using the description of the target task.

Here, the sub-activity differs from each activity registered in the task automation system and may refer to a lower-level activity of a registered activity. For example, an activity corresponding to the first task may be registered in the task automation system, but an activity corresponding to a second task, which is a detailed task subdivided from the first task, may not be registered in the task automation system. In this example, the sub-activity may correspond to the second task. Meanwhile, the sub-activity may also refer to an activity that cannot be automated without user intervention.

In step S102, the activity determination module may input the second prompt generated in step S101 into the LLM to determine the sub-activity. Thereafter, in step S103, the activity determination module may generate an automation scenario corresponding to the target task using the sub-activity determined in step S102. In this case, user intervention may be required to register the sub-activity in the task automation system for the automation scenario to be generated.

FIG. 11 is a detailed flowchart for explaining some of the operations illustrated in FIG. 8. Specifically, FIG. 11 is a flowchart illustrating the process of identifying information not input by the user among attribute information of the activity determined by the activity determination module and substituting it with appropriately named variables.

As illustrated in FIG. 11, step S3000, where at least one activity for processing the target task is determined, may include step S111, where the variable generation module identifies missing activity attribute information in the description of the target task among the attribute information for performing at least one activity for processing the target task; step S112, where the variable generation module generates one or more variables corresponding to the missing attribute information; and step S113, where the variable generation module adds the generated variables to the attribute information of the activity to update the attribute information of the activity.

Meanwhile, steps S111 through S113 may be performed in parallel with the process of determining the activity for processing the target task. However, if steps S111 through S113 are performed by the variable generation module after the activity for processing the target task is determined by the activity determination module, accurate variables corresponding to the activity's attributes may be generated, and an optimal automation scenario that is most suitable for the user's intent may be created based on the generated variables.

Information of a first activity (e.g., “Create File”) determined based on the candidate activity list may include information on the attributes of the first activity (e.g., “File Name,” “File Save Location,” “File Size,” etc.). In this case, there may be cases where the description of the target task input by the user does not include the attribute values of the first activity.

For example, if the user inputs a description of a task for creating a file but omits the value for the creation location (i.e., save location) of the file, the variable generation module may generate a variable (e.g., “file_path”) corresponding to the missing attribute value (e.g., file save location) and register the generated variable in the task automation system. Then, an automation scenario may be generated using the generated variable. That is, even if some attribute values of an activity are missing, the task automation process does not terminate. Instead, variables corresponding to the missing attribute values may be generated, and an automation scenario may be created using the generated variables.

Meanwhile, if all the attribute information of the activity determined by the activity determination module has been input by the user, it may be substituted with one or more variables already registered in the task automation system.

Thus, the attributes of the activity for processing the target task are updated by being substituted with variables corresponding to the attribute information of the corresponding activity, and an automation scenario is generated based on the variables. This allows for easy modification and management of the automation scenario even if the attribute values of the activity are changed in the future.

The methods for providing a task automation service using an LLM according to some embodiments of the present disclosure have been described so far with reference to FIGS. 1 through 11. According to the methods for providing a task automation service using an LLM according to some embodiments of the present disclosure, an automation scenario for various tasks desired by the user may be generated through either the dynamic generation module or the static generation module based on the user's selection input for how to generate the automation scenario. At this time, the dynamic generation module 1b and the static generation module la may determine the most suitable object or activity for the user's desired task by interacting with the LLM, and generate an automation scenario corresponding to the desired task using the determined object or activity.

Therefore, by appropriately using the static generation module la and the dynamic generation module 1b according to the type of task, the optimal automation scenario corresponding to the user's desired task can be provided, thereby effectively enhancing user satisfaction and task convenience.

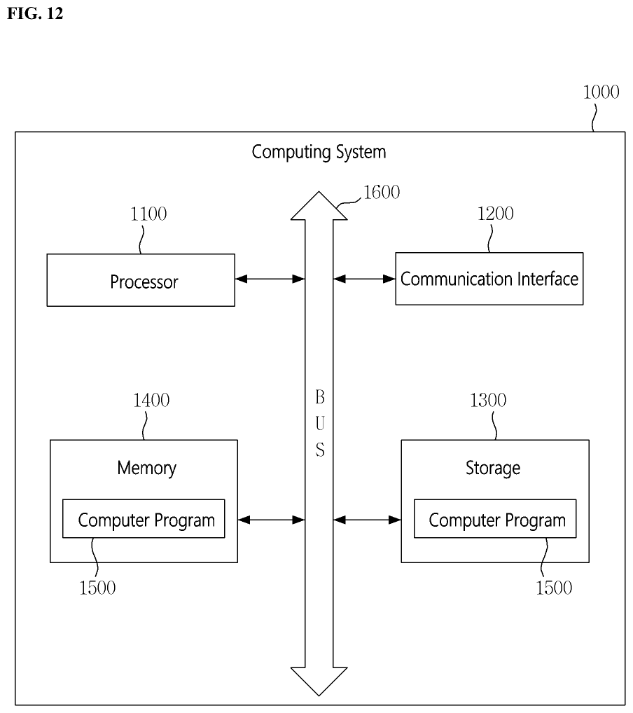

FIG. 12 is a hardware configuration diagram of a system for providing a task automation service using an LLM, according to some embodiments of the present disclosure. Referring to FIG. 12, a system 1000 for providing a task automation service using an LLM may include at least one processor 1100, a system bus 1600, a communication interface 1200, a memory 1400 for loading a computer program 1500 executed by the processor 1100, and a storage 1300 for storing the computer program 1500.

The processor 1100 controls the overall operation of each component of the system 1000. The processor 1100 may perform computations for at least one application or program to execute methods/operations according to various embodiments of the present disclosure. The memory 1400 stores various data, commands, and/or information. The memory 1400 may load at least one computer program 1500 from the storage 1300 to execute the methods/operations according to various embodiments of the present disclosure. The system bus 1600 provides communication functions between the components of the system 1000. The communication interface 1200 supports Internet communication for the system 1000. The storage 1300 may non-temporarily store at least one computer program 1500. The computer program 1500 may include one or more instructions into which the methods/operations according to various embodiments of the present disclosure are implemented. When the computer program 1500 is loaded into the memory 1400, the processor 1100 may execute the one or more instructions to perform the methods/operations according to various embodiments of the present disclosure.

In some embodiments, the system 1000 may be configured using one or more physical servers included in a server farm based on cloud technology, such as a virtual machine. In this case, at least some of the components illustrated in FIG. 12, including the processor 1100, the memory 1400, and the storage 1300, may be virtual hardware, and the communication interface 1200 may also be configured as a virtualized networking element, such as a virtual switch.

Various embodiments of the present disclosure and their effects have been described so far with reference to FIGS. 1 through 12. The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for providing a task automation service using a large-scale language model (LLM), performed by at least one computing device, the method comprising:
receiving a description of a target task;
generating a first object information list by collecting information on a plurality of objects displayed on a first execution screen of a program used for the target task;
selecting at least one candidate object related to the target task from among the plurality of objects by feeding the first object information list and the description of the target task into the LLM;
selecting a first target object from among the at least one candidate object by feeding information of the selected candidate object and the description of the target task into the LLM; and
generating an automation scenario corresponding to the target task based on a first activity related to the first target object.

2. The method of claim 1, wherein the target task is a task involving screen transitions on a user terminal during task processing.

3. The method of claim 1, wherein the target task is an automation task performed using information on objects displayed on a screen of a user terminal.

4. The method of claim 1, wherein the first object information list includes at least one of object identifiers (IDs), object names, and object location information.

5. The method of claim 1, further comprising:
before the selecting the at least one candidate object, determining whether the description of the target task contains security information and modifying the description of the target task by transforming the security information based on a result of the determining.

6. The method of claim 1, wherein the generating the automation scenario corresponding to the target task, comprises: controlling the program using information on the first target object; and generating the first activity corresponding to the first target object only if the program is properly controlled.

7. The method of claim 6, wherein
the information on the first target object includes encrypted text of security information, and
the controlling the program, comprises controlling the program using decrypted data from the encrypted text of the security information.

8. The method of claim 1, wherein the generating the automation scenario, comprises:
updating the first execution screen to a second execution screen by performing the first activity related to the first target object; generating a second object information list by collecting information on a plurality of objects displayed on the second execution screen; selecting a second target object using the collected information; and generating the automation scenario corresponding to the target task based on a second activity related to the second target object.

9. The method of claim 8, wherein the selecting the second target object, comprises: selecting at least one candidate object related to the target task from among the plurality of objects by feeding the second object information list and the description of the target task into the LLM; and selecting the second target object from among the at least one candidate object by feeding the information of the selected candidate object and the description of the target task into the LLM.

10. A method for providing a task automation service using a large-scale language model (LLM), performed by at least one computing device, the method comprising:
receiving a description of a target task;
determining a candidate activity list related to the target task based on the description of the target task;
generating a first prompt for selecting an activity of an automation scenario corresponding to the target task using the description of the target task and information of the candidate activity list, inputting the first prompt into the LLM, and determining at least one activity for processing the target task; and
generating the automation scenario using the at least one activity.

11. The method of claim 10, wherein the target task is a task performed on a single screen of a user terminal.

12. The method of claim 10, wherein the target task is an automation task performed independently of information on objects displayed on a screen of a user terminal.

13. The method of claim 10, wherein the determining the candidate activity list, comprises:
generating a second prompt for selecting the candidate activity list related to the target task using the description of the target task and information of activity lists registered in a task automation system; and
determining the candidate activity list related to the target task by inputting the second prompt into the LLM.

14. The method of claim 10, wherein the determining the at least one activity, comprises: identifying missing attribute information in the description of the target task among attribute information of the at least one activity for performing the at least one activity; generating one or more variables corresponding to the missing attribute information; and updating the attribute information of the at least one activity by adding the one or more variables to the attribute information of the at least one activity.

15. The method of claim 10, further comprising:
if the candidate activity list does not exist, determining a sub-activity for processing the target task using the LLM, and generating the automation scenario corresponding to the target task using the sub-activity.

16. A system for providing a task automation service using a large-scale language model (LLM), the system comprising:
a processor; and
a memory storing instructions,
wherein when executed by the processor, the instructions cause the processor to:
receive a description of a target task; generate a first object information list by collecting information on a plurality of objects displayed on a first execution screen of a program used for the target task; select at least one candidate object related to the target task from among the plurality of objects by feeding the first object information list and the description of the target task into the LLM; select a first target object from among the at least one candidate object by feeding information of the selected candidate object and the description of the target task into the LLM; and generate an automation scenario corresponding to the target task based on a first activity related to the first target object.

17. The system of claim 16, wherein the target task is a task involving screen transitions on a user terminal during task processing.

18. The system of claim 16, wherein when executed by the processor, the instructions further cause the processor to: before selecting the at least one candidate object from among the plurality of objects, make a determination whether the description of the target task contains security information; and modify the description of the target task by transforming the security information based on a result of the determination.

19. A system for providing a task automation service using a large-scale language model (LLM), the system comprising:
a processor; and
a memory storing instructions,
wherein when executed by the processor, the instructions cause the processor to: receive a description of a target task; determine a candidate activity list related to the target task based on the description of the target task; generate a first prompt for selecting an activity of an automation scenario corresponding to the target task using the description of the target task and information of the candidate activity list and determine at least one activity for processing the target task by inputting the first prompt into the LLM; and generate the automation scenario using the at least one activity.

20. The system of claim 19, wherein the target task is a task performed on a single screen of a user terminal.
